(19) United States
(12) Patent Application Publication
(10) Pub. No.: US 2009/0167781 A1
(43) Pub. Date: Jul. 2, 2009

(54) Information Processing Apparatus

(75) Inventor: Kenichiro Nakata, Nara (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi, Osaka (JP)

(21) Appl. No.: 12/089,591

(22) PCT Filed: Oct. 11, 2006
(86) PCT No.: PCT/JP2006/320345

§ 371 Date: Apr. 8, 2008

(30) Foreign Application Priority Data
Oct. 12, 2005 (JP) 2005-298106

(51) Int. Cl. G09G 5/02; G09G 5/36; G09G 5/00

(52) U.S. Cl. 345/596; 345/545; 345/660

(57) ABSTRACT

An information processing apparatus capable of storing more data to a remaining region of a storage portion excluding a frame buffer region while displaying an image by an image display portion, is provided. When free space of a system storage portion has become below a predetermined value, a reduction in number of gray scales of the image results in a reduction in a data amount of image data stored in a display data storage region and a reduction in capacity of the display data storage region. This makes it possible to reduce the data amount of image data and increase the free space of the system storage portion while keeping the size of the image displayed by an image display portion.

### TECHNICAL FIELD

The present invention relates to an information processing apparatus having an image display portion.

### BACKGROUND ART

In such an image display apparatus for displaying an image at high gradient as typified by a liquid crystal display apparatus, a data amount of image data necessary for displaying the image tends to become increasingly larger. The increase in data amount of image data induces a problem that memory capacity required by a driving circuit of the image display apparatus becomes large undesirably.

In view of the problem as mentioned above, for example, in a related art disclosed in Japanese Unexamined Patent Publication JP-A 9-61785 (1997), by controlling writing in such a manner that data which is displayed on image display blocks which are produced by dividing a screen into a plurality of blocks having scanning lines the number of which is integer times as much as the number of scanning lines to be simultaneously selected, is divided into a plurality of memory blocks having a capacity within reading and writing capacity, and that image data corresponding to liquid crystal display devices is written into the respective memory blocks by a driving circuit, and additionally by reading out sequentially image data from memory blocks which are not objects of writing data is read out, while DRAM is used as the memory, from the memory at a substantially high frame frequency.

In the related art, since data amount of image data of one screen which is displayed on a liquid crystal display device is constant, a dual use as both a frame buffer and a memory for storing other data raises a problem of undesirably imposing limitations on an operation of storing data in a storage portion. For example, in a facsimile apparatus having a liquid crystal display device, in the case of storing data received by communication by the facsimile apparatus in a memory, the memory is used for the received data to the extent of a capacity that is as much as a capacity of the memory excluding a capacity for storing image data representing an image displayed on the liquid crystal display device, and however, when the amount of the received data exceeds the capacity for received data, communication by the facsimile apparatus is stopped and data are not received.

### DISCLOSURE OF INVENTION

An object of the invention is to provide an information processing apparatus which is capable of reducing regulations that are imposed on a process of storing data in a storage portion and that are induced by a change in free space of the storage portion, and which is capable of storing more data in a remaining region of the storage portion excluding a frame buffer region while displaying an image by an image display portion.

The invention provides an information processing apparatus comprising:

a storage portion having a frame buffer region for storing image data frame by frame and a remaining region of the storage portion excluding the frame buffer region;

a display portion for displaying the image data stored in the frame buffer region as an image; and

a storage management portion for subjecting image data to be stored in the frame buffer region, to predetermined data processing of reducing a data amount frame by frame, at a predetermined timing when it has been determined based on a change in free space of the storage portion that the free space of the storage portion decreases to be below a predetermined value.

Further, in the invention, it is preferable that the storage management portion reduces the data amount of the image data, by reducing a number of gray scales of the image displayed on the image display portion according to predetermined data processing.

Further, in the invention, it is preferable that the storage management portion reduces the data amount of the image data, by reducing a size of the image displayed on the image display portion according to predetermined data processing.

Further, in the invention, it is preferable that the storage management portion reduces the data amount of the image data, by reducing the number of gray scales and the size of the image displayed on the image display portion according to predetermined data processing.

Further, in the invention, it is preferable that when the free space of the storage portion has become below the predetermined value, the storage management portion determines that the free space of the storage portion decreases to he below the predetermined value.

Further, in the invention, it is preferable that when the storage management portion has predicted based on a data amount of data to be stored in the storage portion that the free space of the storage portion decreases to be below the predetermined value, the storage management portion determines that the free space of the storage portion decreases to be below the predetermined value.

### BRIEF DESCRIPTION OF THE DRAWINGS

Other and further objects, features, and advantages of the invention will be more explicit from the following detailed description taken with reference to the drawings wherein:

FIG. 1 is a block diagram showing a constitution of an information processing apparatus 1 according to one embodiment of the invention;

FIG. 2 is a flowchart showing an operation process of a memory data management portion 13 when data is stored in a system storage portion 5;

FIGS. 3A and 3B are views of assistance in explaining predetermined data processing on how the memory data management portion 13 reduces a data amount of image data in Step S3;

FIGS. 4A and 4B are views of assistance in explaining predetermined data processing on how the memory data management portion 13 reduces the data amount of image data; and

FIGS. 5A and 5B are views of assistance in explaining predetermined data processing on how the memory data management portion 13 reduces the data amount of image data.

### BEST MODE FOR CARRY OUT THE INVENTION

Now referring to the drawings preferred embodiments of the invention are described below.

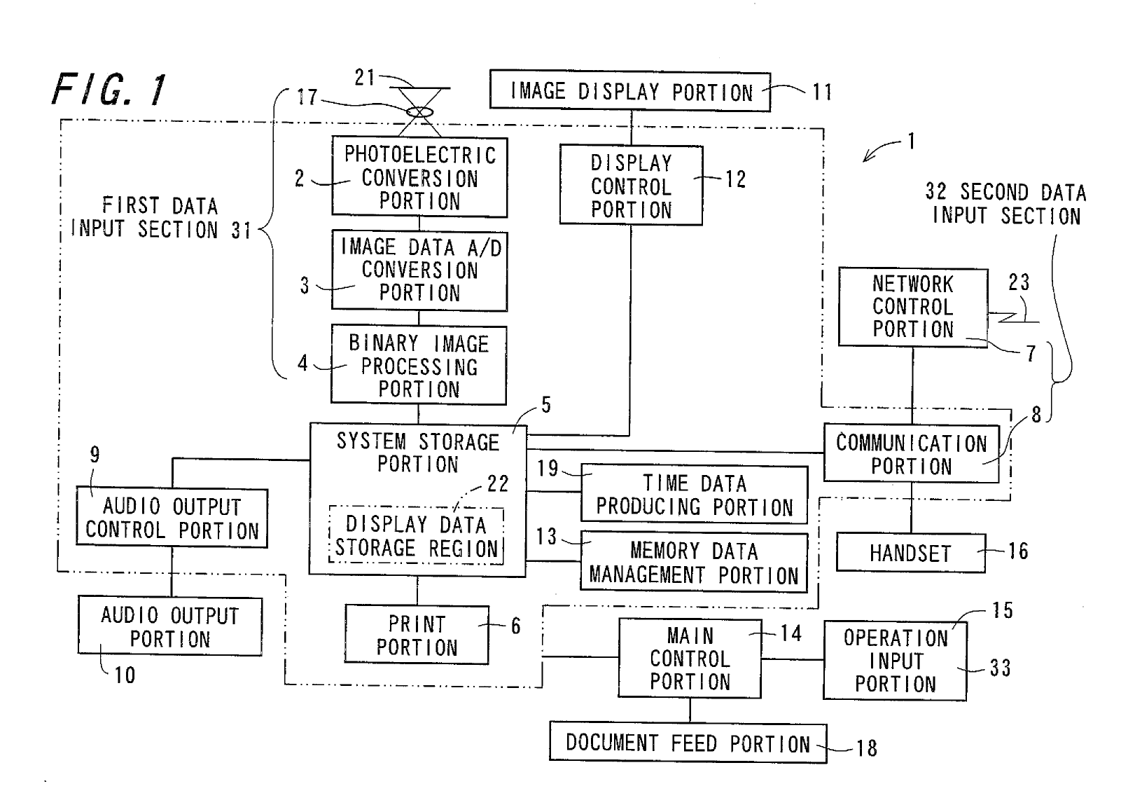

FIG. 1 is a block diagram showing a constitution of an information processing apparatus 1 according to one embodiment of the invention. The information processing apparatus 1 is a telephone facsimile apparatus having a facsimile communication function and a telephone communication function. The information processing apparatus 1 includes a photoelectric conversion portion 2, an image data analog/digital (A/D) conversion portion 3, a binary image processing portion 4, a system storage portion 5, a print portion 6, a network control portion 7, a communication portion 8, an audio output control portion 9, an audio output portion 10, an image display portion 11, a display control portion 12, a memory data management portion 13, a main control portion 14, an operation input portion 15, a handset 16, a lens 17, a document feed portion 18, and a time data producing portion 19.

The photoelectric conversion portion 2 is so constructed as to include a line image sensor achieved by a CCD (charge coupled device) image sensor and operates based on a control instruction given from the main control portion 14, which photoelectric conversion portion 2 reads a document 21 by optically scanning the document 21 through the lens 17 serving as a microlens array and produces image data represented by an analog signal. The photoelectric conversion portion 2 provides the produced image data represented by the analog signal to the image data A/D conversion portion 3.

The image data A/D conversion portion 3 operates based on the control instruction given from the main control portion 14, which image data A/D conversion portion 3 converts the analog signal provided from the photoelectric conversion portion 2 into a digital signal by sampling and quantizing the analog signal. Image data represented by the digital signal is produced by the image data A/D conversion portion 3. The image data A/D conversion portion 3 provides the image data represented by the digital signal to the binary image processing portion 4. A grayscale image is represented according to the image data outputted from the image data A/D conversion portion 3.

The binary image processing portion 4 operates based on the control instruction given from the main control portion 14, which binary image processing portion 4 produces image data of binary image by executing a binarizing process on the image data provided from the image data A/D conversion portion 3. The binary image processing portion 4 provides the produced image data of binary image to the system storage portion 5.

The system storage portion 5 is so constructed as to include a memory with a predetermined storage capacity. The memory is achieved by, for example, a random access memory (abbreviated as RAM). The system storage portion 5 is divided into a display data storage region 22 which is a frame buffer region, and a remaining region of the system storage portion 5 excluding the display data storage region 22. The system storage portion 5 operates based on the control instruction given from the main control portion 14 and stores external data which include the image data thus binarized by the binary image processing portion 4, different types of input data provided from the communication portion 8, and input data provided from the operation input portion 15. The different types of input data provided from the communication portion 8 are data received by the facsimile communication, such as image data and audio data. The data provided from the operation input portion 15 is setting data, telephone number data, facsimile number data, and the like data of the facsimile apparatus which is the information processing apparatus 1. In addition, in the system storage portion 5, there is stored pre-stored image data, such as image data representing time and image data for displaying an image on the image display portion 11 in standby state.

In the display data storage region 22 of the system storage portion 5, the image data is stored frame by frame, that is, screen by screen. At least the external data mentioned above is stored in the remaining region of the system storage portion 5 excluding the display data storage region 22. To be specific, in the remaining region of the system storage portion 5 excluding the display data storage region 22, there are stored control programs by which the main control portion 14 executes control of the information processing apparatus 1, the image data binarized by the binary image processing portion 4, the different types of input data provided from the communication portion 8, the image data representing time, the data of the facsimile apparatus serving as the information processing apparatus 1 such as the setting data, telephone number data and facsimile number, and so forth. The data stored in the remaining region of the system storage portion 5 excluding the display data storage region 22 is filed. Information representing a data amount of a file is added in a header of the file.

In the display data storage region 22 of this embodiment, image data in one frame is stored. In the display data storage region 22 where data is stored in a bitmap format, there is stored data representing a gray scale value of color component of each pixel in images which are displayed in one frame on the image display portion 11. In this embodiment, the RAM of the system storage portion 5 serves as both a system memory and a video RAM (VRAM).

The print portion 6 is so realized as to include a printer apparatus. The print portion operates based on the control instruction given from the main control portion 14, which print portion reads the image data stored in the system storage portion 5 and prints an image, in accordance with the image data, on a piece of recording paper serving as a recording material. In this embodiment, the print portion 6 is achieved by an ink-jet printer apparatus capable of printing a color image.

The network control portion 7 which is connected to a transmission path 23 serving as a public network, connects lines to an exchange connected to the transmission path 23, notifies a telephone number and a facsimile number of the other communication side, or performs disconnection of communication. In a communication state, the network control section 7 receives facsimile data and audio data transmitted through the transmission path 23, provides the received facsimile data and audio data to the communication portion 8, and further transmits, to the transmission path 23, facsimile data and audio data provided from the communication portion 8.

The communication portion 8 operates based on the control instruction given from the main control portion 14, which communication portion 8, in transmitting a facsimile, compresses to-be-transmitted image data according to a predetermined encoding method such as modified Huffman (MH) encoding and modified read (MR) encoding, generates facsimile data by formatting communication information, and provides the facsimile data including the compressed image data to the network control portion 7. In addition, in receiving the facsimile, the communication portion 8 performs a process opposite to the process in transmitting the facsimile, that is, the communication portion 8 decompresses image data included in the facsimile data according to a predetermined decoding method and provides the decompressed image data to the system storage portion 5. When in a telephone message recording mode, the communication portion 8 brings the audio data arriving from the transmission path 23 to the system storage portion 5 where the audio data is stored.

The audio output control portion 9 operates based on the control instruction given from the main control portion 14, which audio output control portion 9 reads out the audio data stored in the system storage portion 5, converts the read-out audio data into audio data represented by analog signals, and provides the audio data represented by analog signals to the audio output portion 10.

The audio output portion 10 outputs a sound based on the audio data provided from the audio output control portion 9. The audio output portion 10 is achieved by a speaker.

The image display portion 11 is constructed so that a color image can be displayed thereon. The image display portion 11 is achieved by, for example, a liquid crystal display panel. The image display portion 11 has a rectangular display screen and can display an image represented by a predetermined number (N×M) or less of pixels, wherein there are N (N is a positive integer) pieces of pixels in a transverse direction and M (M is a positive integer) pieces of pixels in a longitudinal direction.

The display control portion 12 operates based on the control instruction given from the main control portion 14, which display control portion 12 transfers the image data stored in the remaining region of the system storage portion 5 excluding the display data storage region 22 to the display data storage region 22, reads the image data stored in the display data storage region 22, and has the read-out image data displayed on the image display portion 11 as images. In this embodiment, the image display portion 11 is realized by the liquid crystal display panel, so the display control portion 12 is realized by a liquid (crystal display (abbreviated as LCD) controller. A display portion is so constructed as to include the image display portion 11 and the display control portion 12.

The memory data management portion 13 operates based on the control instruction given from the main control portion 14, which memory data management portion 13 reduces, at a predetermined timing when it has been determined that free space of the system storage portion 5 decreases to be below a predetermined value according to a change in the free space of the system storage portion 5, a capacity of the display data storage region 22 by subjecting image data to be stored in the display data storage region 22 to predetermined data processing, namely, decreasing a data amount frame by frame. The free space of the system storage portion 5 refers to the space in system storage portion 5 where no data is stored. The memory data management portion 13 is so realized as to include a central processing unit (abbreviated as CPU), and functions in such a manner that the CPU runs the control programs stored in the system storage portion 5. The memory data management portion 13 monitors the free space of the system storage portion 5, and subjects the image data to be stored in the display data storage region 22 to the predetermined data processing when the free space has become below the predetermined value. The predetermined data processing will be described later on. The memory data management portion 13 specifies the display data storage region 22 in the system storage portion 5 according to an address and capacity. Of the whole storage region in the system storage portion 5, a region having the capacity and the address specified by the memory data management portion 13 is the display data storage region 22. When the capacity of the display data storage region 22 is reduced, in the case where image data is stored in the display data storage region 22, the memory data management portion 13 subjects the image data to the predetermined data processing on image data.

The main control portion 14 executes control of different portions of the information processing apparatus 1 and specifically, the photoelectric conversion portion 2, the image data A/D conversion portion 3, the binary image processing portion 4, the system storage portion 5, the print portion 6, the communication portion 8, the audio output control portion 9, the display control portion 12, the memory management portion 13, the operation input portion 15, and the document feed portion 18. The main control portion 14 is realized in such a manner that the central processing unit executes the control programs stored in the system storage portion 5, and gives the control instruction to the respective portions mentioned above to execute control of the respective portions. The information processing apparatus 1 further has a read only memory (abbreviated as ROM) where a control program is stored. When the information processing apparatus 1 is powered on, the main control portion 14 copies the control program stored in the ROM to the system storage portion 5. The main control portion 14 executes control of the respective portions of apparatus in a facsimile transmitting mode, a facsimile memory receiving mode, a telephone communicating mode, a document reading mode, a message recording mode, a telephone number and facsimile number storing mode, and the like mode, by reading out the control programs stored in the system storage portion 5 and running the control programs thus read out. In the facsimile transmitting mode, the main control portion 14 executes control of the respective portions of apparatus to transmit facsimile data. In the facsimile memory receiving mode, the main control portion 14 executes control of the respective portions of apparatus so that image data included in the received facsimile data is stored in the system storage portion 5. In the telephone communicating mode, the main control portion 14 executes control of the respective portions of apparatus to communicate by telephone. In the document reading mode, the main control portion 14 executes control of the respective portions of apparatus so that the document 21 is read and the image data thus produced is stored in the system storing portion 5. In the message recording mode, the main control portion 14 executes control of the respective portions of apparatus so that received audio data is stored in the system storage portion 5. In the telephone number and facsimile number storing mode, the main control portion 14 executes control of the respective portions of apparatus so that data inputted from the operation input portion 15 such as telephone number data and facsimile number data is stored in the system storage portion 5.

The operation input portion 15 is so constructed as to include an operation panel having operation keys. By manipulating the operation keys, a user can input instructions corresponding to the operation keys. The inputted instructions are provided to the main control portion 14. The operation keys have a numerical keypad and function keys. The function keys include a facsimile transmitting key, a document reading key, a document reading key, a message recording key, and so forth.

In the information processing apparatus 1, the transition to application dedicated modes such as the facsimile transmitting mode, the document reading mode, the message recording mode, and the telephone number and facsimile number storing mode, is carried out by operating the function keys included in the operation input portion 15. For example, an operation for reading a document is performed by operating the document reading key which is operated at the operation input portion 15 in an operation procedure for carrying out facsimile transmission. The transition to the facsimile transmitting mode is performed by operating the facsimile transmitting key, and the transition to the message recording mode is performed by operating the message recording key.

The handset 16 is so constructed as to include a speaker and a microphone, and is connected to the communication portion 8. The handset 16 is so mounted as to be attachable to or detachable from a mounting portion disposed on the apparatus. In the telephone communicating mode, the main control portion 14 connects a line to the network control portion 7 based on telephone number data of communication provided by operating the operation input portion 15, which main control portion provides an audio signal inputted from the handset 16 to the communication portion 8 and transmits the audio signal through the transmission path 23 to the other communication side from the network control portion 7. When telephone communication and facsimile communication through the transmission path 23 are not performed, the main control portion 14 executes control of the respective portions of apparatus in the telephone communicating mode by dismounting the handset 16 from the mounting portion. In the telephone communicating mode, an audio signal provided to the communication portion 8 through the transmission path 23 is provided to the handset 16 and the audio signal is outputted as a sound from the handset 16.

The document feed portion 18 is achieved by an auto document feeder (abbreviated as ADF). The document feed portion 18 operates based on the operation instruction given from the main control portion 14 and delivers a plurality of the documents 21 piece by piece to the region of photoelectric conversion portion 2 where the documents 21 are read, so that the plurality of the documents 21 are read in the photoelectric conversion portion 2.

The time data producing portion 19 is so constructed as to include a real-time clock serving as timing means determines a time, and produces image data representing the time.

A first data input section 31 is so constructed as to include the photoelectric conversion portion 2, the image data A/D conversion portion 3, the binary image processing portion 4, and the lens 17, and a second data input section 32 is so constructed as to include the network control portion 7 and the communication portion 8. In addition, a third data input section 33 is so constructed as to include the operation input portion 15. In the information processing apparatus 1, data inputted by the first data input section 31, the second data input section 32, and the third data input section 33 can be stored in the system storage portion 5. By getting application programs included in the control programs stored in the system storage portion 5 running, the main control portion 14 stores image data inputted by the first data input section 31 to the system storage portion 5, and stores data inputted by the second data input section 32 to the system storage portion 5, and further stores data inputted by the third data input section 33 to the system storage portion 5. The application programs mentioned above include a read operating program which is designed for use in storing the image data to the system storing portion 5 by the utilization of the ADF function using the document feed portion 18 and the first data input section 31 in the read operating mode, a memory receiving program which is designed for use in storing the image data inputted by the second data input section 32 to the system storage portion 5 in the facsimile memory receiving mode, a message recording program which is for use in storing audio data inputted by the second data input section 32 to the system storage portion 5 in the message recording mode, a telephone directory registering program which is designed for use in storing, to the system storage portion 5, the data inputted from the third data input section 33 such as the telephone number data and the facsimile number data in the telephone number and facsimile number storing mode, and the like program.

When the main control portion 14 gets the read operating program running, the information processing apparatus enters the read operating mode, and a memory copy operation is performed by which the documents 21 are delivered by the document feed portion 18, the documents 21 are optically scanned by the photoelectric conversion portion 2 so that image data is read out thereby, and the read-out image data is stored in the system storage portion 5. In the read operating mode, the image data is stored in the system storage portion 5 by way of the photoelectric conversion portion 2, the image data A/D conversion portion 3, and the binary image processing portion 4 in this order. To be specific, the documents 21 are read by the photoelectric conversion portion 2, the image data thus read out is transferred as analog signals to the image data A/D conversion portion 3. The analog signals representing the image data are converted into digital signals and provided to the binary image processing portion 4 by the image data A/D conversion portion 3, and the digital signals are binarized and are brought by the binary image processing portion 4 into the system storage portion 5 where the binarized data is stored. The image data provided from the binary image processing portion 4 is stored in the system storage portion 5 as long as there exists free space, until no free space is left in the system storage portion 5.

In the case of displaying by the image display portion 11, image data to be displayed is transferred by the display control portion 12 from the remaining region of the system storage portion 5 excluding the display data storage region 22 to the display data storage region 22, and the display control portion 12 controls the image display portion 11 so that the image data stored in the display data storage region 22 is displayed as an image by the image display portion 11. In the case of printing the image data stored in the system storage portion 5, the image data stored in the system storage portion 5 is transferred to the print portion 6 and is printed thereby. In addition, in the case of facsimile transmission of the image data stored in the system storage portion 5, the image data of the system storage portion 5 is transferred to the communication portion 8, and after a transmission process of a facsimile communication procedure has been performed by the communication portion 8, the image data is transmitted by the network control portion 7 through the transmission path 23 to a designated transfer destination.

When the main control portion 14 gets the memory receiving program running, the information processing apparatus enters the facsimile memory accessing mode, and a memory alternate receiving operation is performed by which image data received by facsimile communication through the transmission path 23 is stored to the system storage portion 5. In the facsimile memory receiving mode, the image data that is included in the facsimile data transmitted through the transmission path 23, is stored in the system storage portion 5 by way of the network control portion 7 and the communication portion 8 in this order. To be specific, the facsimile data which include image data transmitted by the transmission path 23, is received by the network control portion 7. The network control portion 7 sends the received facsimile data to the communication portion 8, and the communication portion 8 performs a receiving process based on the facsimile communication procedure and provides the image data to the system storage portion 5. The image data provided from the communication 8 is stored in the system storage portion 5 as long as there exists free space in the system storage portion 5, until no free space is left in the system storage portion 5.

When the main control portion 14 gets the message recording program running, the information processing apparatus enters the message recording mode, a message recording operation is performed by which audio data received by the transmission path 23 is stored to the system storage portion 5. In the message recording mode, the audio data transmitted through the transmission path 23 is stored in the system storage portion 5. In the message recording mode, the audio data provided through the transmission path 23 is received by the network control section 7 and is transferred to the communication portion 8. The communication portion 8 having an audio data A/D conversion part, converts the audio data which is provided from the network control section 7 and is represented by analog signals, into audio data represented by digital signals, and transfers the audio data to the system storage portion 5. In the case of outputting a sound representing the audio data stored in the system storage portion 5, the audio data is transferred from the system storage portion 5 to the audio output control portion 9. The audio output control portion 9 having a decompression processing part and an audio data D/A conversion part, decompresses the compressed data provided from the system storage portion 5 by the decompression processing part and converts the audio data represented by digital signals into the audio data represented by analog signals, so that the sound representing the audio data is outputted from the audio output portion 10.

In the information processing apparatus 1, the memory data management portion 13 alters the capacity of the display data storage region 22 in the system storage portion 5 in accordance with a ratio of a data amount of the data stored in the system storage portion 5 relative to the full capacity of the system storage portion 5, in other words, in accordance with the free space of the system storage portion 5.

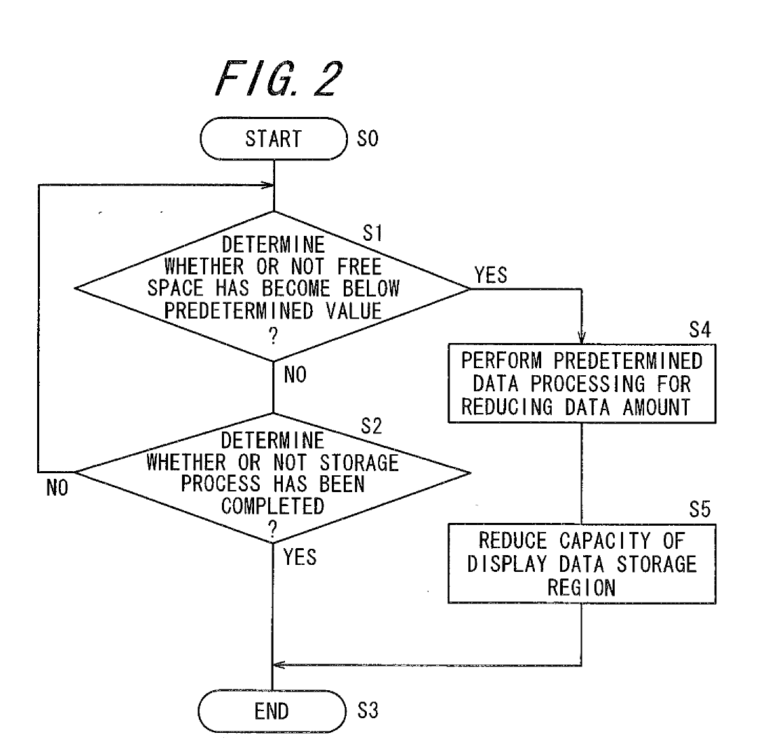

FIG. 2 is a flowchart showing an operation process of the memory data management portion 13 when the data is stored in the system storage portion 5. Here, in Step S0, the free space of the system storage portion 5 is greater than a predetermined value and the capacity of the display data storage region 22 is maximized. The capacity of the display data storage region 22 in Step S0 is set to be C1. In the information processing apparatus 1, the main control portion 14 updates image data representing time produced by the time data producing portion 19, and brings the image data thus updated into the system storage portion 5 where the updated image data is stored. A predetermined interval T1 is selected to be, for example, 1 minute, at which images representing time stored in the system storage portion 5 are updated. The display control portion 12 transfers the image data representing time to the display data storage region 22 once every the predetermined interval T1. In Step S0, the display control portion 12 controls the image display portion 11 so that the image data representing time stored in the display data storage region 22 is displayed as an image by the image display portion 11.

An operation instruction is provided to the memory data management portion 13 from the main control portion 14 so that the operation process proceeds to Step S1 from Step S0, upon the input of, from the operation input portion 15, an instruction to execute the aforementioned control program the execution of which thereupon causes the transition to the read operating mode, or upon the provision of facsimile data through the transmission path 23 by means of facsimile communication in the facsimile memory receiving mode, or upon the provision of the audio data through the transmission path 23 by means of telephone communication after there has been inputted an instruction to execute the control program the execution of which thereupon causes the transition to the message recording mode, or upon the input of an instruction to execute the control program the execution of which thereupon causes the transition to the telephone number and facsimile number recording mode.

Upon the transition to the read operating mode, the facsimile memory receiving mode, the message recording mode, or the telephone number and facsimile number recording mode, the main control portion 14 executes control of the system storage portion 5 as well as the first data input section 31 or the second data input section 32 or the third data input section 33, and starts to bring data into the system storage portion 5 where the data is stored. In the read operating mode, the main control portion 14 executes control of the first data input section 31 and the system storage portion 5, so that the documents 21 are read and the image data thus read out is stored in the region of the system storage portion 5 excluding the display data storage region 22. In the facsimile memory receiving mode, the main control portion 14 executes control of the section data input section 32 and the system storage portion 5, so that facsimile data is received and image data included in the received facsimile data is stored in the region of the system storage portion 5 excluding the display data storage region 22. In the message recording mode, the main control portion 14 executes control of the second data input section 32 and the system storage portion 5, so that audio data is received and the received audio data is compressed and stored in the region of the system storage portion 5 excluding the display data storage region 22. In the telephone number and facsimile number storing mode, the main control portion 14 executes control of the system storage portion 5 so that the data inputted from the third data input section 33 is stored in the region of the system storage portion 5 excluding the display data storage region 22.

In Step S1, the memory data management portion 13 monitors the system storage portion 5 and determines whether or not the free space of the system storage portion 5 has become below the predetermined value. When the memory data management portion 13 determines that the free space of the system storage portion 5 has not become below the predetermined value in Step S1, the operation process goes to Step S2.

In Step S2, the memory data management portion 13 determines whether or not the process of storing the data in the system storage portion 5 has been completed or not. When it is determined that the process of storing the data in the system storage portion 5 has been completed, the main control portion 14 sends the memory data management portion 13 a piece of ending information which represents that the process of storing the data in the system storage portion 5 has been completed. Depending on whether or not the ending information is received from the main control portion 14, the memory data management portion 13 determines whether or not the process of storing the data in the system storage portion 5 has been completed. Tn the case where it is determined in Step S2 that the process of storing the data in the system storage portion 5 has been completed, the operation process goes to Step S3 and the operation process is completed. In the case where it is determined in Step S2 that the process of storing the data in the system storage portion 5 has not been completed, the operation process goes to Step S1.

When the memory data management portion 13 determines in Step S1 that the free space of the system storage portion 5 has become from equal to or greater than the predetermined value to below the predetermined value, the operation process goes to Step S4. The predetermined value is a system-tailored value and is determined, for example, in accordance with specifications of product such as audio recording time and received copies of read image data, so that the predetermined value remains in such a scope that the specifications of product can be fulfilled. For example, the predetermined value is selected to be larger than a data amount of image data that is produced in reading a piece of the document 21, and is selected to be larger than a data amount of image data of one facsimile image, and further is selected to be larger than a data amount of audio data stored by one message recording.

In Step S4, the memory data management portion 13 subjects the image data stored in the display data storage region 22 to predetermined data processing for reducing a data amount frame by frame to reduce the data amount, and then the operation process goes to Step S5. The predetermined data processing will be described later on.

The memory data management portion 13 reduces the capacity of the display data storage region 22 in Step S5, and the operation process goes to Step S3. In Step S5, the memory data management portion 13 reduces the capacity of the display data storage region 22 by specifying an address and capacity of the region of system storage portion 5 which is to be the display data storage region 22. After the process of Step S5 has been completed, the capacity of the display data storage region 22 is set to be C2, and C2 is less than C1. A value calculated by subtracting C2 from C1 is equal to a value calculated by subtracting the data amount of image data of which data amount is reduced in Step S4 from the data amount of image data stored in the display data storage region 22 in Step S0. When the process of Step S5 has been completed, the operation process goes to Step S3 and the operation process is completed. The reduction in the capacity of the display data storage region 22 makes it possible to increase, in executing the control programs, storage capacity of a part for storing data to be inputted by the first data input section 31, the section data input section 32, or the third data input section 33.

When the free space of the system storage portion 5 is equal to or greater than the predetermined value while the image data is being stored in the system storage portion 5, the memory data management portion 13 monitors a change in system status, and the processes of Step S1 and Step S2 for checking the system storage portion 5 are repeated upon the change being detected. The memory data management portion 13 monitors the change in the system status and detects the change, for example, at intervals of 1 ms. In this way, when the free space of the system storage portion 5 becomes from equal to or greater than the predetermined value to below the predetermined value, the memory data management portion 13 can promptly detect that the free space of the system storage portion 5 has become below the predetermined value, and the free space of the system storage portion 5 can be promptly increased correspondingly.

In addition, the memory data management portion 13 detects the free space of the system storage portion 5, and sends information representing existence of no free space to the main control portion 14 when no free space has been left in the system storage portion 5. Upon receiving the information representing existence of no free space provided from the memory data management portion 13, the main control portion 14 executes controls described below when determining that the data inputted from the first data input section 31, the second data input section 32, and the third data input section 33 cannot be stored. When in the document reading mode, the main control portion 14 executes control of the respective portions of apparatus so that the readout of the documents 21 is stopped and the information representing existence of no free space is displayed on the image display portion 11. When in the facsimile memory receiving mode, the main control portion 14 executes control of the respective portions of apparatus, so that the image data of received image data which cannot be stored in the system storage portion 5 is provided to the print portion 6 where the image data thus provided is printed, and the information representing existence of no free space is displayed on the image display portion 11. When in the message recording mode, the main control portion 14 executes control of the respective portions of apparatus, so that message audio data for encouraging to call again is delivered to the transmission path 23 and the information representing existence of no free space is displayed on the image display portion 11. When in the telephone number and facsimile number storing mode, the main control portion 14 executes control of the respective portions of apparatus so that the information representing existence of no free space is displayed on the image display portion 11. When no free space is left in the system storage portion 5, the processes cannot be continued in the respective operating modes and therefore, it is necessary to regulate the processes in the respective operating modes, that is, stop the operations. However, in the information processing apparatus 1, the free space of the system storage portion 5 having a limited capacity is increased by reducing the capacity of the display data storage region 22 of the system storage portion 5 and therefore, the regulations on input process in the operating modes mentioned above can be reduced, thus making it possible to maintain and further continue the processes in the respective operating modes while displaying the image by the image display portion 11.

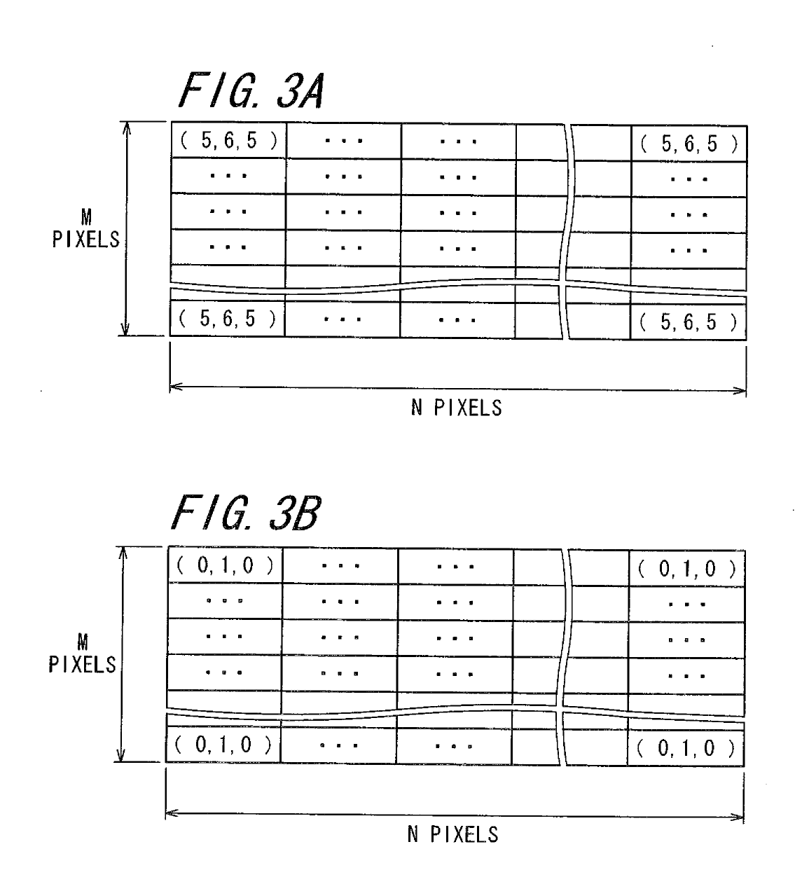

FIGS. 3A and 3B are views of assistance in explaining the predetermined data processing on how the memory data management portion 13 reduces the data amount of image data in Step 3 mentioned above. FIG. 3A is a view showing gray scale values of all pixels of the image data that have not been reduced in a data amount, and FIG. 3B is a view showing gray scale values of all pixels of the image data that have been reduced in a data amount. In this embodiment, the memory data management portion 13 alters the data amount of the image data stored in the display data storage region 22 by reducing the gray scale values of the image displayed by the image display portion 11. In FIGS. 3A and 3B, every pixel of one frame is represented by a part enclosed by a matrix-like box, and values listed in the respective boxes represent gray scale values of red (R), green (G), and blue (B), respectively. The color of each pixel of the image displayed on the image display portion 11 is represented by teaming red, green, and blue. Here, the number of gray scales for red is set at five, the number of gray scales for green is set at six, and the number of gray scales for blue is set at five. Correspondingly, a data amount of data of one pixel is represented by 5 bits for red, 6 bits for green, and 5 bits for blue, and therefore the data amount of data of one pixel is 16 bits. In FIGS. 3A and 3B, in a case where the gray scale value for red is set at “a” (“a” is a positive integer), the gray scale value for green is set at “b” (“b” is a positive integer), and the gray scale value for blue is set at “c” (“c” is a positive integer), the gray scale value of the pixel is represented as “(a, b, c)”.

When number of pixel of the image displayed by the image display portion 11 is N×M (N and M are positive integers), a data amount of image data of one screen is N×M×16 bits. The capacity of the display data storage region 22 is N×M×16 bits in Step S0. In this embodiment, a display size of the image display portion 11 is a video graphics array (VGA) size (640×480 pixel), and a color image represented by, for example, 65536 (i.e., 65 k) colors is converted into a binary image which has the same size as the color image and is represented by one color. The data amount of the color image having 65 k colors is 640×480×16 bits, namely 614.4 kilobytes (KB). In addition, the data amount of the binary image is 640×480×1 bits, namely 38.4 kilobytes (KB). Here, among red, green, and blue, the binary image is represented by only green. In the case of converting the color image into the green binary image, data of red and data of blue are not needed. Further, when the gray scale value for green is three or less, the gray scale value is set at zero in the binary image, and when the gray scale value for green is greater than 3, the gray scale value is set at 1 in the binary image. In the binary image, one pixel is not represented by 16 bits but can be represented by 1 bit, and therefore in the image data of one screen, a data amount can be reduced to 1/16 of the data amount of the color image. In this embodiment, the reduction in the capacity of the display data storage region 22 can secure an addition of free space, and here, capacity of the added free space is 576 KB calculated by subtracting 38.4 KB from 614.4 KB. In accordance with a data format of the display data storage region 22 which has been reduced in capacity, the display control portion 12 executes control of the image display portion 11 so that an image is displayed by the image control portion 11.

As described above, in the information processing apparatus 1, when the free space of the system storage portion 5 has become below the predetermined value, the data amount of the display data storage region 22 can be reduced and the capacity of the region of the system storage portion 5 excluding the display data storage region 22 is increased with this reduction, thus making it possible to increase the region of system storage portion 5 for storing the data inputted by the first data input section 31, the second data input section 32, and the third data input section 33. Accordingly, even without increasing the storage capacity of the storage portion 5, it is possible to reduce the regulations on the process of storing data in the system storage portion 5, thereby making it possible to store, in the system storage portion 5, more data to be inputted by the first data input section 31, the second data input section 32, and the third data input section 33.

In addition, the data amount of the image data stored in the display data storage region 22 is reduced and the capacity of the display data storage region 22 is reduced by reducing the number of gray scales of the image to be displayed, and therefore it is possible to reduce the data amount of image data and increase the free space in the system storage portion 5 while keeping the size of the image displayed by the image display portion 11. As the number of gray scales of an image represented by the image data is higher, the data amount of the image data becomes larger. A reduction in the number of gray scales of the image causes a reduction in the data amount of the image data according to a simple process of altering a data amount of image data, thus making it possible for the memory data management portion 13 to promptly increase the free space of the system storage portion 5 when the free space of the system storage portion 5 has become below the predetermined value and making it possible to smoothly switch the image displayed by the image display portion 11.

In the information processing apparatus 1, when it is determined that the free space of system storage portion being monitored by the memory data management portion 13 has become equal to or greater than the predetermined value, the capacity of the display data storage region 22 is expanded. A process of expanding the capacity of the display data storage region 22 is opposite to the aforementioned process of reducing the capacity of the display data storage region 22. When the capacity of the display data storage region 22 is expanded, the capacity 640×480×1 bits (38.4 KB) capable of storing the data of the binary image is increased to the capacity 640×480×16 bits (614.4 KB) capable of storing the data of the color image having 65 k colors.

After the display data storage region 22 has been reduced, the main control portion 14 executes control of the display control portion 12 when no free space in the system storage portion 5 has been left, so that image data representing existence of no free space in the system storage portion 5 is stored in the image data storage region 22 and the display control portion 12 controls the image display portion 11 so that an image representing existence of no free space in the system storage portion 5 is displayed by the image display portion 11. In this way, it is possible to notify the user that there is no free space left in the system storage portion 5. In the operation input portion 15, there is disposed a delete-instruction input key which is designed for inputting an instruction to delete the data stored in the system storage portion 5. By operating the delete-instruction input key, the main control portion 14 deletes the data stored in the system storage portion 5. By doing do, it is possible to increase the free space of the system storage portion 5.

In an information processing apparatus according to another embodiment of the invention, the data amount of the image data stored in the display data storage region 22 may be reduced in Step S3 of the flowchart shown in FIGS. 3A and 3B mentioned above, according to predetermined data processing for reducing frame by frame the size of the image displayed by the image display portion 11. The information processing apparatus according to this embodiment has basically the same structure as that of the information processing apparatus 1 according to the aforementioned embodiment, except for the difference in predetermined data processing for reducing the data amount of image data, and therefore the constituent components that play the same or corresponding roles as in the information processing apparatus 1 will be identified with the same reference numerals and overlapping descriptions will be omitted.

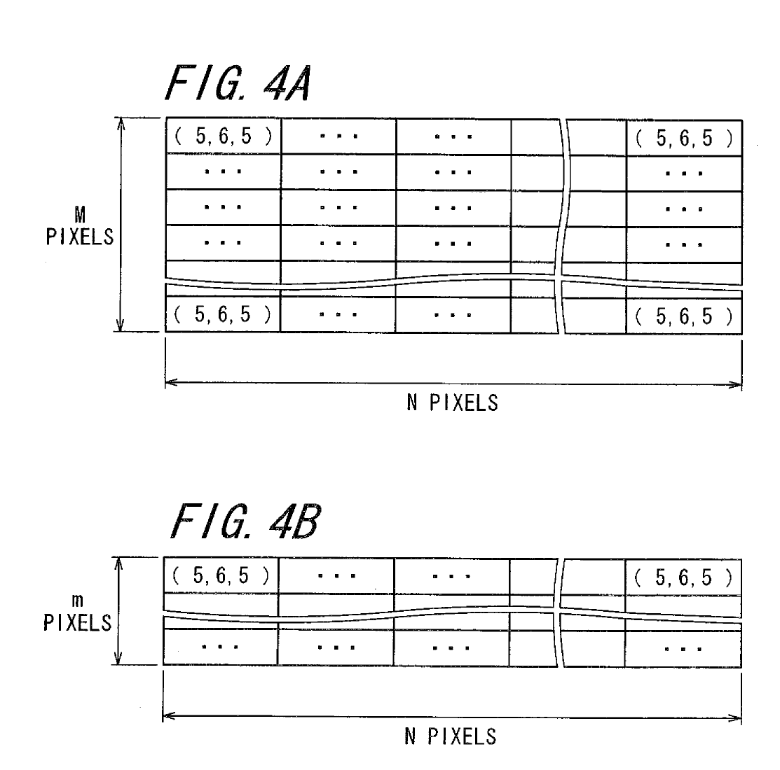

FIGS. 4A and 4B are views of assistance in explaining a process on how the memory data management portion 13 reduces the data amount of image data in this embodiment. FIG. 4A is a view showing sizes of image data that have not been reduced in a data amount and FIG. 4B is a view showing sizes of all pixels of the image data that have been reduced in a data amount. In FIGS. 4A and 4B, every pixel of one frame is represented by a part enclosed by a matrix-like box, and values listed in the respective boxes represent gray scale values of red (R), green (G), and blue (B), respectively. The color of each pixel of the image displayed on the image display portion 11 is represented by teaming red, green, and blue. Here, the number of gray scales for red is set at five, the number of gray scales for green is set at six, and the number of gray scales for blue is set at five. Correspondingly, a data amount of data of one pixel is represented by 5 bits for red, 6 bits for green, and 5 bits for blue, and therefore the data amount of data of one pixel is 16 bits. In FIGS. 4A and 4B, in a case where the gray scale value for red is set at “a” (“a” is a positive integer), the gray scale value for green is set at “b” (“b” is a positive integer), and the gray scale value for blue is set at “c” (“c” is a positive integer), the gray scale value of the pixel is represented as “(a, b, c)”.

When number of pixel of the image displayed by the image display portion 11 is N×M (N and M are positive integers), the capacity of the display data storage region 22 is N×M×16 bits in Step S0. In this embodiment, a display size of the image display portion 11 is set to be the VGA size, and a size of an image which is displayed on the image display portion 11 according to the image data reduced in a data amount is set to be N×m pixels (N and m are positive integers). The positive integer m is selected to be smaller than the positive integer M. For example, when assuming N to be a value 640 and m to be a value 8, the capacity of the display data storage region 22 is 640×8×16 bits, namely 10.2 KB (kilobytes). In this embodiment, a reduction in the capacity of the display data storage region 22 can secure an addition of free space in the system storage portion 5, and the capacity of the added free space is 604.2 KB calculated by subtracting 10.2 KB from 614.4 KB. The capacity of the reduced display data storage region 5 is so selected as to be possible to store the image data representing existence of no free space in the system storage portion 5.

In an information processing apparatus according to still another embodiment of the invention, the data amount of the image data stored in the display data storage region 22 is altered in Step S3 of the flowchart shown in FIG. 2 mentioned above, by performing predetermined data processing for reducing frame by frame number of gray scales as well as sizes of the image displayed by the image display portion 11. The information processing apparatus according to this embodiment has basically the same structure as the information processing apparatus 1 according to the aforementioned embodiment, and therefore the constituent components that play the same or corresponding roles as in the information processing apparatus 1 according to the aforementioned embodiment will be identified with the same reference numerals, and overlapping descriptions will be omitted.

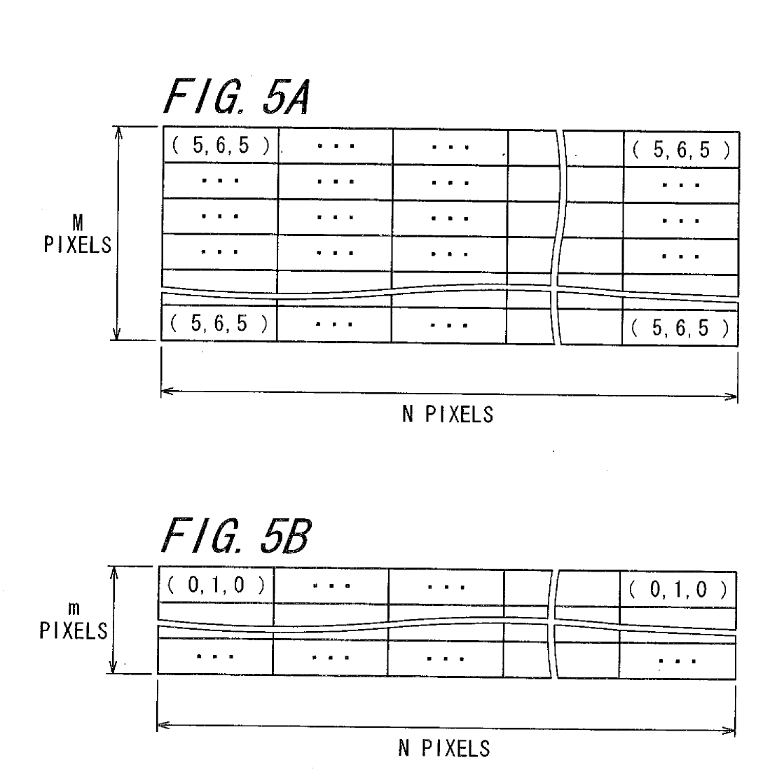

FIGS. 5A and 5B are views of assistance in explaining a process on how the memory data management portion 13 reduces the data amount of image data. FIG. 5A is a view showing sizes of the image data that have not been reduced in a data amount and FIG. 5B is a view showing sizes of all pixels of the image data that have been reduced in a data amount. In FIGS. 5A and 5B, every pixel of one frame is represented by a part enclosed by a matrix-like box, and values listed in the respective boxes represent gray scale values of red (R), green (G), and blue (B), respectively. The color of each pixel of the image displayed in the image display portion 11 is represented by teaming red, green, and blue. Here, the number of gray scales for red is set at five, the number of gray scales for green is set at six, and the number of gray scales for blue is set at five. Correspondingly, a data amount of data of one pixel is represented by 5 bits for red, 6 bits for green, and 5 bits for blue, and therefore the data amount of data of one pixel is 16 bits. In FIGS. 5A and 5B, in a case where the gray scale value for red is set at “a” (“a” is a positive integer), the gray scale value for green is set at “b” (“b” is a positive integer), and the gray scale value for blue is set at “c” (“c” is a positive integer), the gray scale value of the pixel is represented as “(a, b, c)”.

When number of pixel of the image displayed in the image display portion 11 is N×M (N and M are positive integers), a data amount is N×M×16 bits. In this embodiment, a display size of the image display portion 11 is set to be the VGA size, the number of gray scales of the image which is displayed on the image display portion 11 according to the image data reduced in a data amount is set at two, and the size of the image reduced in a data amount is set to be N×m pixels. For example, when assuming N to be a value 640 and m to be a value 8, the capacity of the display data storage region 22 is 640×8×1 bits, namely 640 B (bytes). In this embodiment, the reduction in the capacity of the display data storage region 22 can secure a free space to be added to the system storage portion 5, and here, capacity of the added free space is 613.76 KB calculated by subtracting 640 B from 614.4 KB, thus making it possible to further expand the free space secured by addition.

In the information processing apparatuses according to the respective embodiments of the invention, an image representing time is displayed on the image display portion 11. The image representing time as mentioned above represents a numerical character, and sufficiently functions as information representing time even when the number of gray scales is reduced, or when the image size is reduced, or when the number of gray scales and the image size are reduced simultaneously. In the information processing apparatuses according to the respective embodiments of the invention, even when the displayed image is poor in quality, a data amount of image data representing a practically problem-free image is reduced according to the aforementioned predetermined data processing. Accordingly, even when the image displayed on the image display portion 11 is poor in quality, the user can identify the displayed image.

In an information processing apparatus according to still another embodiment of the invention, a constitution may be adopted where the image data produced by the binary image processing portion 4 and the image data received by the communication portion 8 in the information processing apparatuses according to the aforementioned respective embodiments, are compressed according to a predetermined encoding method and the data thus compressed is stored in the system storage portion 5. More information can be stored in the system storage portion 5, by compressing the image data and storing the image data thus compressed in the system storage portion 5. In this embodiment, in displaying the image on the image display portion 11, the display control portion 12 has a data decompressing part for decompressing compressed image data, thus making it possible to decompress the compressed data by using the data decompressing part and store the data thus decompressed in the display data storage region 22.

In the respective embodiments of the invention, a constitution may be adopted where the memory data management portion 13 predicts, in Step S1 of the operation process shown in the flowchart shown of FIG. 2 mentioned above, whether or not the free space of the system storage portion 5 becomes below the predetermined value based on a data amount of data to be stored in the system storage portion 5, so that the operation process goes to Step S2 when it has been determined that the free space of the system storage portion 5 does not become below the predetermined value, and the operation process goes to Step 4 when it has been determined that the free space of the system storage portion 5 becomes below the predetermined value. The memory data management portion 13 predicts the free space of the system storage portion 5 based on information which represents a data amount of to-be stored data in the system storage portion 5 and which is stored in a header. In the system storage portion 5, the data is stored in data files. In the data files, information representing a data amount of a data file is added to a header corresponding to the data file. The memory data management portion 13 acquires the Information which represents a data amount and which is added to the header of the data file, and calculates, based on the acquired information representing a data amount, the free space of the system storage portion 5 in storing this data amount of data in the system storage portion 5, and further determines that the calculated free space is below the predetermined value in the case where the calculated free space is below the predetermined value.

In the case of performing the process of reducing the capacity of the display data storage region 22 while the data is being stored in the system storage portion 5, it is necessary to temporarily stop the operation for storing the data in the system storage portion 5. However, in this embodiment, the memory data management portion 13 predicts whether or not the free space of the system storage portion 13 becomes below the predetermined value, thus making it possible to perform the process of reducing the capacity of the display data storage region 22 before data to be stored in the system storage portion 5 is stored. Accordingly, it is not necessary to stop the recording operation for storing data in the system storage portion 5, thus making it possible to improve processing efficiency.

In the respective embodiments of the invention, a constitution may be adopted where the memory data management portion 13 predicts, in Step S2 of the flowchart shown of FIG. 2 mentioned above, whether or not the free space of the system storage portion 5 becomes below the predetermined value based on a data amount of data to be stored in the system storage portion 5, so that the operation process goes to Step S2 when it has been determined that the free space of the system storage portion 5 does not become below the predetermined value, and the operation process goes to Step S4 when it has been determined that the free space of the system storage portion 5 becomes below the predetermined value. According to the constitution as mentioned above, before the free space of the system storage portion 5 actually becomes below the predetermined value, the capacity of the display data storage region 22 can be reduced and the free space can be increased.

Although the information processing apparatuses according to the respective embodiments of the invention are realized as facsimile apparatuses having telephone function, the invention is not limited thereto, and an information processing apparatus according to still another embodiment of the invention has an image display portion for displaying an image and may be applied to a personal computer having a unified memory architecture (UMA) where a system memory and a video memory are concomitantly used.

In the respective embodiments of the invention, the user may set the predetermined value mentioned above by use of the operation input portion 15. Applications having a common buffer as well as specifications of a liquid display apparatus used in a system (an information processing apparatus) vary from system to system, and therefore it is necessary to set a system-tailored suitable value as the predetermined value. However, the user can set the predetermined value, and therefore it is possible to secure enough capacity to store data which is undesirably lost conventionally due to fullness in a memory when the user is absent, such as data obtained by message recording, received data, and so forth.

In the respective embodiments of the invention, plural frames of image data, that is, plural screens of image data may be stored in the display data storage region 22. In this case, in reducing the capacity of the display data storage region 22, the memory data management portion 13 reduces the data amount of the image data by performing a predetermined process on the image data of the respective frames, thus making it possible to obtain the same effect.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

### INDUSTRIAL APPLICABILITY

According to the invention, a storage portion has a frame buffer region and a remaining region of the storage portion excluding the frame buffer region. Image data is stored frame by frame, that is, screen by screen in the frame buffer region, and the image data stored in the frame buffer is displayed as an image on a display portion.

Free space of the storage portion varies with a data amount of data stored in the storage portion. At a predetermined timing when it has been determined that the free space of the storage portion so changes as to decrease to be below a predetermined value, a storage management portion subject image data to be stored in the frame buffer region to predetermined data processing, and therefore before the free space of the storage portion decreases so that the data cannot be stored therein, a data amount of the image data to be stored in the frame buffer region is reduced and capacity of the frame buffer region is reduced, thus making it possible to increase the free space of the storage portion. In this way, more data can be stored in the remaining region of the storage portion excluding the frame buffer region, and therefore without any increase in the storage capacity of the storage portion, it is possible to reduce regulations on the storage process of storing in the storage portion limited in capacity while displaying the image by an image display portion.

In the predetermined data processing, the data amount is reduced frame by frame, and therefore the free space of the storage portion can be increased according to the data processing in an amount as much as a value calculated by subtracting the data amount of image data that have been processed by the predetermined data processing from the data amount of image data that have not been processed by the predetermined data processing, and further, image data of one frame is only reduced in a data amount but is not completely-lost, thus making it possible to display an image on the image display portion according to the image data reduced in a data amount.

Further, according to the invention, the storage management portion alters the data amount of the image data stored in the frame buffer region and reduces the capacity of the frame buffer region by reducing a number of gray scales of the image displayed on the image display portion, and therefore it is possible to reduce the data amount of the image data and increase the free space of the storage portion while keeping the size of the image displayed by the image display portion. As the number of gray scales becomes greater, the data amount of the image data becomes larger. According to a simple process of altering the data amount of the image data by reducing the number of gray scales of the image, the data amount of image data can be reduced, and therefore it is possible for the storage management portion to promptly increase the free space of the storage portion, thus making it possible to smoothly switch the image displayed on the image display portion to an image reduced in number of gray scales which is further displayed.

Further, according to the invention, the storage management portion reduces the data amount of the image data stored in the frame buffer region and reduces the capacity of the frame buffer region by reducing the size of the image displayed by the image display portion, and therefore it is possible to reduce the data amount of the image data and increase the free space of the storage portion without reducing the number of gray scales. As the size of the image becomes greater, the data amount of the image data becomes larger. According to a simple process of altering the data amount of image data by reducing the size of the image, the data amount of the image data can be reduced, and therefore the storage management portion can promptly increase the free space of the storage portion, thus making it possible to smoothly switch the image displayed by the image display portion to an image reduced in number of gray scales which is further displayed.

Further, according to the invention, a display management portion reduces the data amount of the image data stored in the frame buffer region and reduces the capacity of the frame buffer region by reducing the number of gray scales of the image displayed by the image display portion and reducing the size of the image displayed by the image display portion, and therefore the free space of the storage portion can be increased in a large way. As the number of gray scales of the image becomes greater and the size of the image becomes greater, the data amount of image data becomes larger. According to a simple process of altering the data amount of the image data by reducing the number of gray scales of the image and reducing the size of the image, the data amount of the image data can be reduced, and therefore the storage management portion can promptly increase the free space of the storage portion, thus making it possible to smoothly switch the image displayed by the image display portion to an image reduced in number of gray scales and in size which is further displayed.

Further, according to the invention, when the actual free space of the storage portion has become below the predetermined value, the storage management portion reduces the data amount of image data by performing the predetermined data processing, thus making it possible to reduce the capacity of the frame buffer region. When the actual free space of the storage portion has become below the predetermined value, the capacity of the frame buffer region can be reduced according to the predetermined process only when the free space is actually reduced.

Further, according to the invention, it is possible to predict that the data cannot be stored in the storage portion and then reduce the capacity of the frame buffer region correspondingly. The storage management portion predicts the free space based on the information that represents the data amount and that is stored in a header or the like added to the data. When it has been predicted that the free space of the storage portion decreases to be below the predetermined value, the predetermined processing can prevent it from occurring, while the data is being stored in the storage portion, that the free space is used up and the data cannot be stored.

1. An information processing apparatus comprising:
a storage portion having a frame buffer region for storing image data frame by frame and a remaining region of the storage portion excluding the frame buffer region;
a display portion for displaying the image data stored in the frame buffer region as an image; and
a storage management portion for subjecting image data to be stored in the frame buffer region, to predetermined data processing of reducing a data amount frame by frame, at a predetermined timing when it has been determined based on a change in free space of the storage portion that the free space of the storage portion decreases to be below a predetermined value.

2. The information processing apparatus of claim 1, wherein the storage management portion reduces the data amount of the image data, by reducing a number of gray scales of the image displayed on the image display portion according to predetermined data processing.

3. The information processing apparatus of claim 1, wherein the storage management portion reduces the data amount of the image data, by reducing a size of the image displayed on the image display portion according to predetermined data processing.

4. The information processing apparatus of claim 1, wherein the storage management portion reduces the data amount of the image data, by reducing the number of gray scales and the size of the image displayed on the image display portion according to predetermined data processing.

5. The information processing apparatus of claim 1, wherein when the free space of the storage portion has become below the predetermined value, the storage management portion determines that the free space of the storage portion decreases to be below the predetermined value.

6. The information processing apparatus of claim 1, wherein when the storage management portion has predicted based on a data amount of data to be stored in the storage portion that the free space of the storage portion decreases to be below the predetermined value, the storage management portion determines that the free space of the storage portion decreases to be below the predetermined value.

7. The information processing apparatus of claim 2, wherein when the free space of the storage portion has become below the predetermined value, the storage management portion determines that the free space of the storage portion decreases to be below the predetermined value.

8. The information processing apparatus of claim 3, wherein when the free space of the storage portion has become below the predetermined value, the storage management portion determines that the free space of the storage portion decreases to be below the predetermined value.

9. The information processing apparatus of claim 4, wherein when the free space of the storage portion has become below the predetermined value, the storage management portion determines that the free space of the storage portion decreases to be below the predetermined value.

10. The information processing apparatus of claim 2, wherein when the storage management portion has predicted based on a data amount of data to be stored in the storage portion that the free space of the storage portion decreases to be below the predetermined value, the storage management portion determines that the free space of the storage portion decreases to be below the predetermined value.

11. The information processing apparatus of claim 3, wherein when the storage management portion has predicted based on a data amount of data to be stored in the storage portion that the free space of the storage portion decreases to be below the predetermined value, the storage management portion determines that the free space of the storage portion decreases to be below the predetermined value.

12. The information processing apparatus of claim 4, wherein when the storage management portion has predicted based on a data amount of data to be stored in the storage portion that the free space of the storage portion decreases to be below the predetermined value, the storage management portion determines that the free space of the storage portion decreases to be below the predetermined value.

13. The information processing apparatus of claim 5, wherein when the storage management portion has predicted based on a data amount of data to be stored in the storage portion that the free space of the storage portion decreases to be below the predetermined value, the storage management portion determines that the free space of the storage portion decreases to be below the predetermined value.

14. The information processing apparatus of claim 7, wherein when the storage management portion has predicted based on a data amount of data to be stored in the storage portion that the free space of the storage portion decreases to be below the predetermined value, the storage management portion determines that the free space of the storage portion decreases to be below the predetermined value.

15. The information processing apparatus of claim 8, wherein when the storage management portion has predicted based on a data amount of data to be stored in the storage portion that the free space of the storage portion decreases to be below the predetermined value, the storage management portion determines that the free space of the storage portion decreases to be below the predetermined value.

16. The information processing apparatus of claim 9, wherein when the storage management portion has predicted based on a data amount of data to be stored in the storage portion that the free space of the storage portion decreases to be below the predetermined value, the storage management portion determines that the free space of the storage portion decreases to be below the predetermined value.
